(19) United States
(12) Patent Application Publication
(10) Pub. No.: US 2023/0063113 A1
(43) Pub. Date: Mar. 2, 2023

(54) AUTO DISCOVERY PROTOCOL AND VIRTUAL GROUPING OF MACHINE LEARNING MODELS

(71) Applicant: INTERNATIONAL BUSINESS MACHINES CORPORATION, ARMONK, NY (US)

(72) Inventors: Craig M. Trim, Ventura, CA (US); Faried Abrahams, Laytonsville, MD (US); Gandhi Sivakumar, Bentleigh (AU); Kushal S. Patel, Pune (IN); Sarvesh S. Patel, Pune (IN)

(21) Appl. No.: 17/412,312

(22) Filed: Aug. 26, 2021

(51) Int. Cl. G06F 16/28; G06N 20/00

(52) U.S. Cl. CPC G06F 16/285; G06F 16/283; G06N 20/00

(57) ABSTRACT

A computer executes a discovery protocol, where the discovery protocol identifies each of the machine learning models and groups the machine learning models into one or more virtual groups based on criteria, and where the auto discovery program is injected to each of the machine learning models. The computer identifies an input to a machine learning model, where the input comprises a plurality of features that processed by the machine learning model. Based on determining a distance of the input is above an acceptable threshold the computer identifies an alternative machine learning model from the machine learning models, and transfers the input to the alternative machine learning model.

### BACKGROUND

The present invention relates, generally, to the field of computing, and more particularly to dynamic auto discovery tool for machine learning models.

Machine learning models (MLM) are part of computer-based cognitive capabilities enabled via Big Data platforms that enrich the automation of human needs to provide more dynamic responses to complex questions in a computerized environment. The MLMs are typically responsible for analyzing input feature sets by applying an adaptive mathematical model that is used as a basis for genesis in order to generate the desired output coupled with the confidence score representing a reliability of the output. The output may vary based on the type of the MLM, the algorithm of the MLM, the input training corpus used to train the MLM, and other interrelated fields. The MLMs may be classified by models such as a regression model, that is dependent on the needs of the environment. Typically, a cognitive system incorporates many similar MLMs with various functions and operation feature-sets to generate a requested output.

### SUMMARY

According to one embodiment, a method, computer system, and computer program product for discovering and grouping of machine learning models is provided. The present invention may include a computer executes a discovery protocol, where the discovery protocol identifies each of the machine learning models and groups the machine learning models into one or more virtual groups based on criteria, and where the auto discovery program is injected to each of the machine learning models. The computer identifies an input to a machine learning model, where the input comprises a plurality of features that processed by the machine learning model. Based on determining a distance of the input is above an acceptable threshold the computer identifies an alternative machine learning model from the machine learning models, and transfers the input to the alternative machine learning model.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 is an operational block diagram illustrating an auto discovery program integrated in each machine learning model in an environment according to at least one embodiment;

FIG. 3 is a flowchart of the auto discovery program according to at least one embodiment;

FIG. 4 is a block diagram of internal and external components of computers and servers depicted in FIG. 1 according to at least one embodiment;

FIG. 5 depicts a cloud computing environment according to an embodiment of the present invention; and

FIG. 6 depicts abstraction model layers according to an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

Embodiments of the present invention relate to the field of computing, and more particularly to a dynamic auto discovery tool for machine learning models. The following described exemplary embodiments provide a system, method, and program product to, among other things, establish a protocol and communicate between all of the available MLMs in an environment and utilize an alternative MLM whenever one of the MLMs provide unreliable result or was not trained to provide a desired output. Therefore, the present embodiment has the capacity to improve the technical field of machine learning performance by organizing all the available MLMs and using an alternative MLM whenever the input or the output is outside a predetermine threshold.

As previously described, machine learning models (MLMs) are part of computer-based cognitive capabilities enabled via Big Data platforms that enrich the automation of human needs to provide more dynamic responses to complex questions in a computerized environment. The MLMs are typically responsible for analyzing input feature sets by applying an adaptive mathematical model that is used as a basis for genesis in order to generate the desired output coupled with the confidence score representing a reliability of the output. The output may vary based on the type of the MLM, the algorithm of the MLM, the input training corpus used to train the MLM, and other interrelated fields. The MLMs may be classified by models such as a regression model, that is dependent on the needs of the environment. Typically, a cognitive system incorporates many similar MLMs with various functions and operation feature-sets to generate a requested output.

For example, one of the emerging ecosystems for dissimilar machine learning modeling is 5G service orchestration layer. In the 5G domain level orchestration, the cognitive orchestration services are being deployed that utilize various MLMs to get the real time cognition capabilities for user data analysis. In such type of machine learning applications, there may be thousands of MLMs that are deployed to make the network cognitive and efficient. Typically, each of the MLMs has a set of training data that builds the ground truth of each of the MLMs. When a computational task is received, the MLM computes the results against the ground truth generated by the training corpus. Whenever the current task (an input to an MLM) is not in the acceptable range, i.e. not covered by the ground truth derived from the training data, the confidence score is unreliable thus the computer is unable to determine an issue with the functioning of the model.

Theoretically, due to multiple MLMs being available in an ecosystem, an analysis from alternative MLMs may be utilized into consideration when the input distance is more or less than the threshold value of the specific MLM ground truth. This utilization of alternative MLMs in the ecosystem cannot be currently attempted because of no available connections or communications between the MLMs currently exists, especially in a cloud environment.

As such, it may be advantageous to, among other things, implement a system that enables communication and discoverability between all of the available MLMs in an ecosystem without rewriting the code or re-designing its capabilities. The proposed method, of using an auto discovery program and a dedicated protocol may enable utilizing MLMs that offer similar output with same or different input parameters, feature sets and different computation matrices for output derivation and usage when current MLM is unable to provide a reliable output or having a confidence score (value) below a threshold set by a user.

According to one embodiment, a discovery program may be injected or added in each MLM that enables discovering of all of the available MLMs, grouping the MLMs based on the inputs, outputs, availability and/or compliance factors for optimal service request re-assignment. The re-assignment of service request may be due to unacceptable results or, in further embodiments, in order to balance a load between operating MLMs.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method, and program product to establish a protocol and communicate between all of the available MLMs in an environment and utilize an alternative MLM whenever one of the MLMs provide unreliable result or was not trained to provide a desired output.

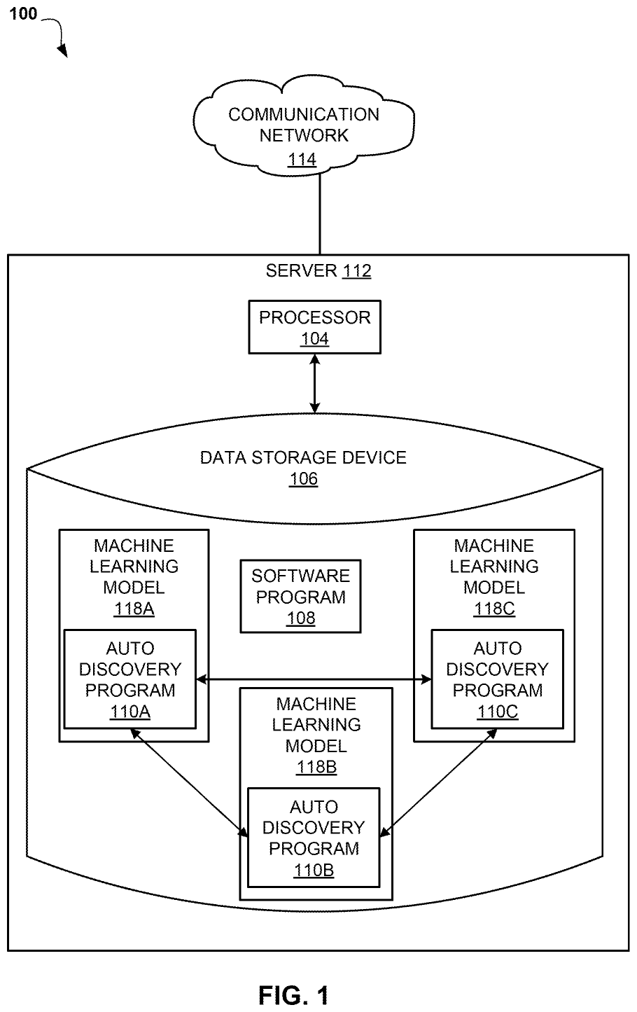

Referring to FIG. 1, an exemplary networked computer environment 100 is depicted, according to at least one embodiment. The networked computer environment 100 may include one or more servers such as a server 112 interconnected via a communication network 114 to one or more computing devices or other servers (not depicted). According to at least one implementation, the networked computer environment 100 may include a plurality of servers, of which only one is shown for illustrative brevity.

The communication network 114 may include various types of communication networks, such as a wide area network (WAN), local area network (LAN), a telecommunication network, a wireless network, a public switched network and/or a satellite network. The communication network 114 may include connections, such as wire, wireless communication links, or fiber optic cables. It may be appreciated that FIG. 1 provides only an illustration of one implementation and does not imply any limitations with regard to the environments in which different embodiments may be implemented. Many modifications to the depicted environments may be made based on design and implementation requirements.

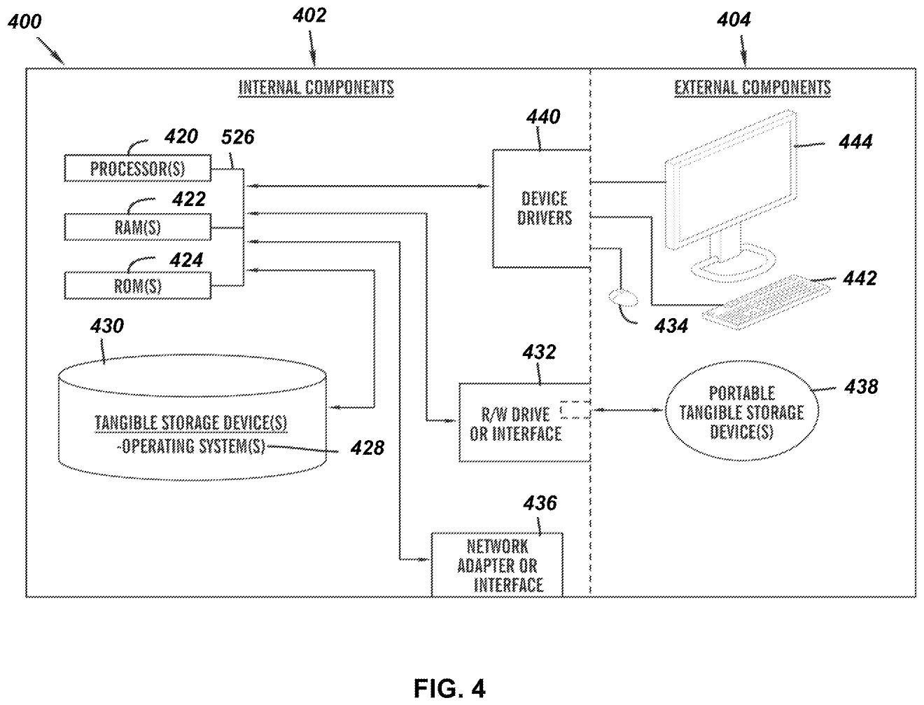

The server computer 112 may include a processor 104 and a data storage device 106 that is enabled to host and run a software program 108, machine learning models 118A-118C that incorporate corresponding auto discover programs 110A-110C. The server computer 112 may be a laptop computer, netbook computer, personal computer (PC), a desktop computer, or any programmable electronic device or any network of programmable electronic devices communicating via the communication network 114, in accordance with embodiments of the invention. As will be discussed with reference to FIG. 4, the server 112 may include internal components 402 and external components 404, respectively. The server 112 may also operate in a cloud computing service model, such as Software as a Service (SaaS), Platform as a Service (PaaS), or Infrastructure as a Service (IaaS). The server 112 may also be located in a cloud computing deployment model, such as a private cloud, community cloud, public cloud, or hybrid cloud.

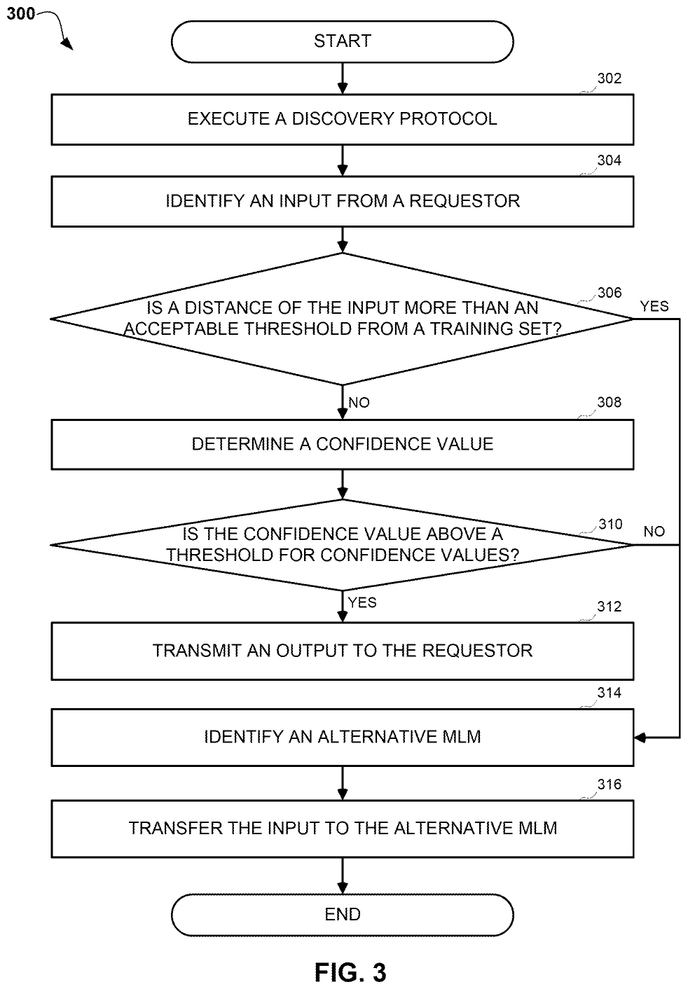

According to the present embodiment, the auto discovery program (ADP) 110A, 110B, 110C may be a program capable of identifying parameters of machine learning model (MLM) 118A, 118B and 118C respectively, and share the identified parameters with each other in order to transfer inputs from one MLM to another. The auto discovery method is explained in further detail below with respect to FIG. 3.

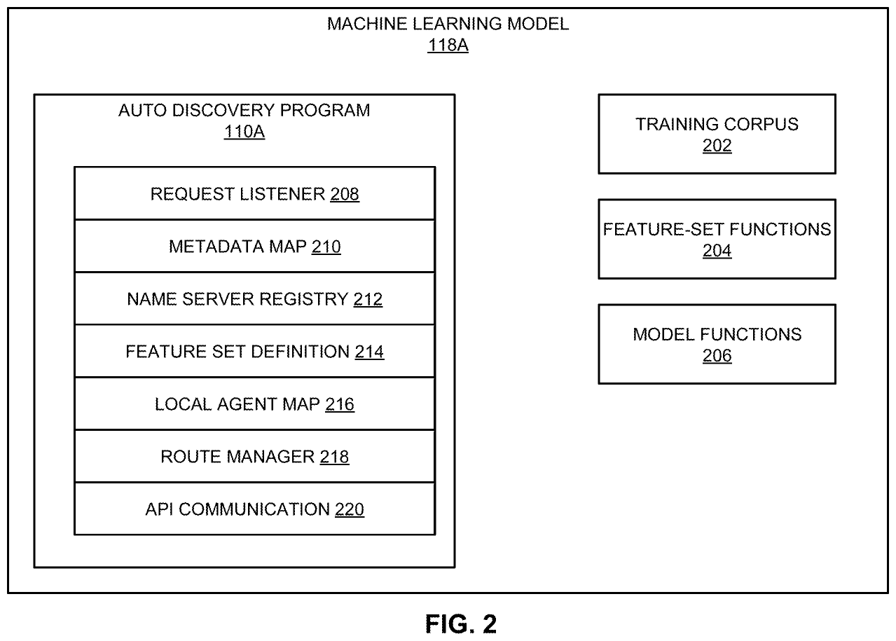

Referring now to FIG. 2, an operational block diagram of an ADP 110A within the machine learning model 118A is depicted. Although not depicted, ADP 110B, 110C have the same structure. Typically, the machine learning model 118A may include a training corpus 202, feature-set functions 204, model functions 206 and, according to the present embodiment, an auto discovery program 110A. The training corpus 202 may be a set or table of training samples used to train the machine learning model 118A. The feature-set functions 204 may be a program that is trained by the training corpus 202 and process features/variables after training, while the model functions 206 may be a set of functions of the machine learning model 118A.

According to the present embodiment, auto discovery program (ADP) 110A may be a software program integrated in the MLM 118A that enables a discovery protocol that may comprise of various components such as: a request listener 208, a metadata map 210, a name server registry 212, a feature set definition 214, a local agent map 216, a route manager 218 and an API communication 220. The request listener 208 may be a software component capable of identifying an input received by the MLM 118A. The request listener 208 may be a program that intercepts all of the features/variables that are transferred as an input to the MLM 118A. The metadata map 210 may be a software component or a combination of software and databases capable of storing a flowchart of relations between all of the available MLMs and their status as identified by the protocol, such as ADP 110A-110C. The feature set definition 214 may be a software component capable of identifying features of the feature-set functions 204 and features/variables required by the MLM 118A that typically identified by analyzing training corpus 202 and stored in feature-set functions 204. The local agent map 216 may be a database that stores a virtual group of alternative MLMs that have similar or identical variables/features as an inputs and same outputs, where the method of identifying and generating the virtual group is described below with respect to FIG. 3. The route manager 218 and the API communication 220 are software components that enable communications and data transfer between the ADP 110A-110C.

Referring now to FIG. 3, an operational flowchart illustrating an auto discovery process 300 is depicted according to at least one embodiment. At 302, the auto discovery program (ADP) 110A-110C executes a discovery protocol. According to an example embodiment, the ADP 110A-110C communicates with each other and establish a connection using an API communication of each of the ADPs, such as API communication 220 of the MLM 118A. According to an example embodiment, the ADP 110A-110C may use a discovery triggering approaches such as star-based topology or may use a cascade topology models, depending on the system configuration and user preferences and thus, identify all of the MLMs in the environment. During the discovery data exchange, the ADP 110A-110C may exchange parameters like model functions, operating feature sets, training information and accuracy of each of the MLMs the ADP 110A-110C controls and save the discovery data in a metadata map, such as metadata map 210. Then, each of the ADP 110A-110C may updates its local map of MLMs in the plane in local agent map 216 and all the MLMs may be discovered with the metadata map exchange along with their reachability paths stored by the route manager 218. After all of the existing MLMs are discovered, ADP 110A-110C may organize the MLMs such as MLM 118A-118C in virtual groups based on capabilities and functionality of each group, where the functionality may be determined based on type of models like classification or regression models along with the feature set information of the model received from the feature set definition 214 of each of the ADPs.

According to one of the embodiments, the ADP 110A-110C may create an omnidirectional virtual group of MLMs that may be based on a primary MLM. This approach may be used because of the feature set differentiation in each model that may be augmented or deflected. For example, if a first MLM has feature-set of variables {x, y, z} while another MLM has feature-set of {w, x, y, z}, then at the time of virtual grouping considerations, the ADP 110A-110C associated with the first MLM may be replaced by another MLM. However, a reverse direction is not possible because the variable {w} does not exist in the first MLM, hence omnidirectional groups are preferred.

According to one of the embodiments, the ADP 110A-110C may group discovered MLMs in a virtual group and store it in local agent map 216 based on all or part of the following criteria:

(a) Model function, set of variables/features, output

(b) Classification or regression

(c) Accuracy or precision of the MLM

(d) Retrain frequency of the MLM

(e) Feedbacks from the users

(f) Based on security compliance rules (whether MLM is compliant to a specific rule)

(g) Timeframe of MLM activity or age of the MLM since deployment

In another embodiment, the ADP 110A-110C may extrapolate missing features/variables using fake feature generation mechanisms. These fake features mechanisms may be added as a separate sub-group of an MLM that requires additional inputs and may be used based on the computation demand or configuration settings of the MLM.

Next, at 304, the ADP 110A-110C identify an input from a requestor. According to an example embodiment, the ADP 110A-110C may intercept an input to each of the machine learning models 118A-118C using a request listener component, such as a request listener 208 (FIG. 2) of the ADP 110A for preprocessing as described below.

Then, at 306, the ADP 110A-110C determines whether a distance of the input is more than an acceptable threshold from a training set. According to an example embodiment, the ADP 110A-110C may access the training set of the MLM, such as training corpus 202 of the machine learning model 118A and identify ranges of each of the input features/variables. The ranges may be calculated anytime when the training corpus 202 is updated. According to an example embodiment, the ADP 110A-110C may then calculate a distance of the input variables/features from the training corpus 202 based on statistical analysis, such as an outlier. If the ADP 110A-110C determines that the distance is above acceptable threshold values set by a user (step 306, “YES” branch), the ADP 110A-110C may continue to step 314 to identify an alternative MLM. If the ADP 110A-110C determines that the distance is below acceptable threshold values (step 306, “NO” branch), the ADP 110A-110C may continue to step 308 to determine a confidence value associated with the output of the MLM. In another embodiment, the distance to the input may be determined by comparing each feature of the input to the range of the same feature in the training set and when at least one feature from the input is outside the range then the distance is more than an acceptable threshold.

Next, at 308, the ADP 110A-110C determines a confidence value. According to an example embodiment, the ADP 110A-110C may use the input to generate an output of the MLM and set the confidence value that was generated by the MLM. In another embodiment, the ADP 110A-110C may normalize the confidence value to a predetermined scale when each MLM has a different scale for confidence values associated with the output. For example, if one MLM uses a percentage range to represent the confidence value, the ADP 110A-110C may normalize all of the confidence values to a range between 0 and 1 or, alternatively, have a different set of acceptable threshold values for different ranges of the confidence values.

Then, at 310, the ADP 110A-110C determines whether confidence value is above a threshold for confidence values set by a user. According to an example embodiment, the ADP 110A-110C may compare the confidence value generated by the MLM to the threshold for confidence values to identify whether the MLM is certain in the output. If the ADP 110A-110C determines that the confidence value is above a threshold for confidence values (step 310, “YES” branch), the ADP 110A-110C may continue to step 312 to transfer the output to the requestor. If the ADP 110A-110C determines that the distance is below an acceptable threshold value (step 310, “NO” branch), the ADP 110A-110C may continue to step 314 to identify an alternative MLM.

Next, at 312, the ADP 110A-110C transmits an output to the requestor. According to an example embodiment, the ADP 110A-110C may transmit the output of the MLM it controls (machine learning model 118A-118C) to an entity that requested the output. The requester may be a user, a program or another MLM that may use the output as part of an input.

Then, at 314, the ADP 110A-110C identifies an alternative MLM. According to an example embodiment, when the distance of the input is more than an acceptable threshold value or when the output has an associated confidence value below the threshold value set by a user, the ADP 110A-110C may identify an alternative MLM from the local agent map 216 that has at least the same input variables/features and same output classification.

Next, at 316, the ADP 110A-110C transfers the input to the alternate MLM. According to an example embodiment, the ADP 110A-110C may act as a requestor and send the variables/features to any other available MLM for processing.

It may be appreciated that FIG. 3 provides only an illustration of one implementation and does not imply any limitations with regard to how different embodiments may be implemented. Many modifications to the depicted environments may be made based on design and implementation requirements.

FIG. 4 is a block diagram 400 of internal and external components of the server 112 depicted in FIG. 1 in accordance with an embodiment of the present invention. It should be appreciated that FIG. 4 provides only an illustration of one implementation and does not imply any limitations with regard to the environments in which different embodiments may be implemented. Many modifications to the depicted environments may be made based on design and implementation requirements.

The data processing system 402, 404 is representative of any electronic device capable of executing machine-readable program instructions. The data processing system 402, 404 may be representative of a smart phone, a computer system, PDA, or other electronic devices. Examples of computing systems, environments, and/or configurations that may represented by the data processing system 402, 404 include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

The server 112 may include one or more sets of internal components 402 and external components 404 illustrated in FIG. 4. Each of the sets of internal components 402 include one or more processors 420, one or more computer-readable RAMs 422, and one or more computer-readable ROMs 424 on one or more buses 426, and one or more operating systems 428 and one or more computer-readable tangible storage devices 430. The one or more operating systems 428, the software program 108 and the ADP 110A-110C in the server 112 are stored on one or more of the respective computer-readable tangible storage devices 430 for execution by one or more of the respective processors 420 via one or more of the respective RAMs 422 (which typically include cache memory). In the embodiment illustrated in FIG. 4, each of the computer-readable tangible storage devices 430 is a magnetic disk storage device of an internal hard drive. Alternatively, each of the computer-readable tangible storage devices 430 is a semiconductor storage device such as ROM 424, EPROM, flash memory or any other computer-readable tangible storage device that can store a computer program and digital information.

Each set of internal components 402 also includes a R/W drive or interface 432 to read from and write to one or more portable computer-readable tangible storage devices 438 such as a CD-ROM, DVD, memory stick, magnetic tape, magnetic disk, optical disk or semiconductor storage device. A software program, such as the ADP 110A-110C, can be stored on one or more of the respective portable computer-readable tangible storage devices 438, read via the respective R/W drive or interface 432, and loaded into the respective hard drive 430.

Each set of internal components 402 also includes network adapters or interfaces 436 such as a TCP/IP adapter cards, wireless Wi-Fi interface cards, or 3G 4G, or 5G wireless interface cards or other wired or wireless communication links. The software program 108 and the ADP 110A-110C in the server 112 can be downloaded to the server 112 from an external computer via a network (for example, the Internet, a local area network or other, wide area network) and respective network adapters or interfaces 436. From the network adapters or interfaces 436, the software program 108 and the ADP 110A-110C in the server 112 are loaded into the respective hard drive 430. The network may comprise copper wires, optical fibers, wireless transmission, routers, firewalls, switches, gateway computers and/or edge servers.

Each of the sets of external components 404 can include a computer display monitor 444, a keyboard 442, and a computer mouse 434. External components 304 a,b can also include touch screens, virtual keyboards, touch pads, pointing devices, and other human interface devices. Each of the sets of internal components 402 also includes device drivers 440 to interface to computer display monitor 444, keyboard 442, and computer mouse 434. The device drivers 440, R/W drive or interface 432, and network adapter or interface 436 comprise hardware and software (stored in storage device 430 and/or ROM 424).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as Follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

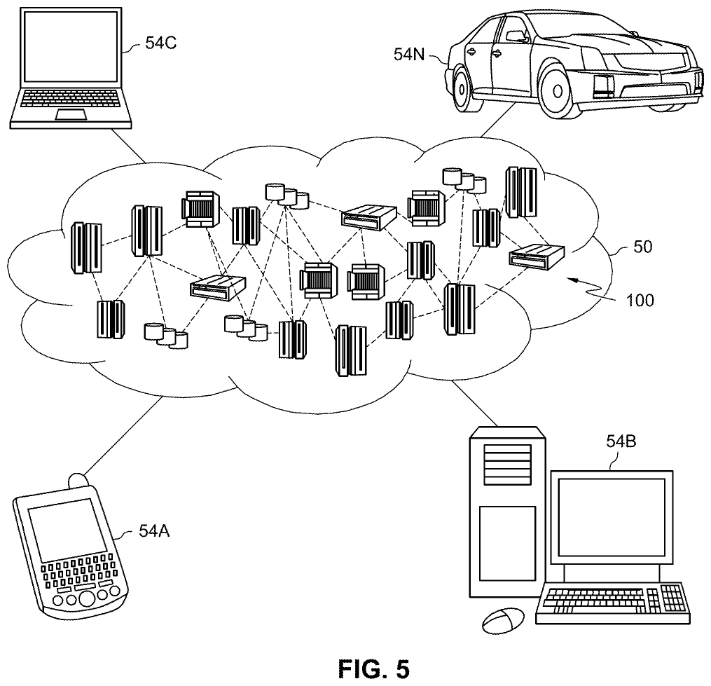

Referring now to FIG. 5, illustrative cloud computing environment 50 is depicted. As shown, cloud computing environment 50 comprises one or more cloud computing nodes 100 with which local computing devices used by cloud consumers, such as, for example, personal digital assistant (PDA) or cellular telephone 54A, desktop computer 54B, laptop computer 54C, and/or automobile computer system 54N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 5 are intended to be illustrative only and that computing nodes 100 and cloud computing environment 50 can communicate with any type of computerized device over any type of network and/or network addressable connection (e.g., using a web browser).

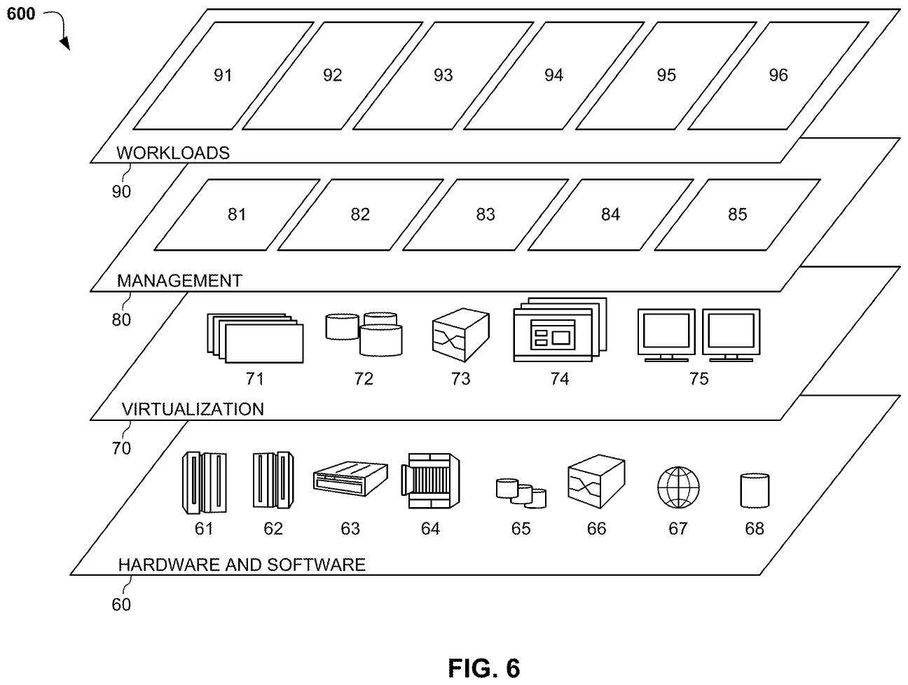

Referring now to FIG. 6, a set of functional abstraction layers 600 provided by cloud computing environment 50 is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and auto discovery protocol for machine learning models (MLM) 96. Auto discovery protocol for machine learning models 96 may relate to injecting an auto discovering program into each available MLM that establish communications and share data related to each of the available MLM that enables using an alternative MLM when the current MLM receives an input that is outside of the training set that the MLM was trained with or when the confidence value associated with the output of the MLM is below a threshold value.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method for discovering and grouping of machine learning models, the method comprising:
executing, by an auto discovery program, a discovery protocol, wherein the discovery protocol identifies each of the machine learning models and groups the machine learning models into one or more virtual groups based on criteria, and wherein the auto discovery program is injected to each of the machine learning models;
identifying, by the auto discovery program, an input to a machine learning model, wherein the input comprises a plurality of features that processed by the machine learning model;
based on determining a distance of the input is above an acceptable threshold:
identifying an alternative machine learning model from the machine learning models; and
transferring, by the auto discovery program, the input to the alternative machine learning model.

2. The method of claim 1, wherein the one or more virtual groups are omnidirectional based on a primary machine learning model from the machine learning models.

3. The method of claim 1, further comprising:
determining a confidence value generated by the machine learning model; and
based on determining the confidence value is below a threshold for confidence values transferring, by the auto discovery program, the input to the alternative machine learning model.

4. The method of claim 1, wherein the criteria relate to a group consisting of: a model function, a set of variables, an output, a classification, an accuracy of precision, a retrain frequency, feedbacks from users, security compliance rules, or a timeframe of activity of the machine learning model.

5. The method of claim 1, wherein determining the distance of the input further comprises:
determining a range for each of the plurality of features from a training set for the machine learning model; and
calculating an outlier of each feature from the input to the range of the feature from the plurality of feature.

6. The method of claim 1, wherein identifying the alternative machine learning model from the machine learning models further comprises:
determining the virtual group of the machine learning model; and
identifying the alternative machine learning model from the virtual group.

7. The method of claim 1, wherein transferring, by the auto discovery program, the input to the alternative machine learning model further comprises extrapolating missing features from the input is by fake feature generation mechanisms.

8. A computer system for discovering and grouping of machine learning models, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
executing, by an auto discovery program, a discovery protocol, wherein the discovery protocol identifies each of the machine learning models and groups the machine learning models into one or more virtual groups based on criteria, and wherein the auto discovery program is injected to each of the machine learning models;
identifying, by the auto discovery program, an input to a machine learning model, wherein the input comprises a plurality of features that processed by the machine learning model;
based on determining a distance of the input is above an acceptable threshold:
identifying an alternative machine learning model from the machine learning models; and
transferring, by the auto discovery program, the input to the alternative machine learning model.

9. The computer system of claim 8, wherein the one or more virtual groups are omnidirectional based on a primary machine learning model from the machine learning models.

10. The computer system of claim 8, further comprising:
determining a confidence value generated by the machine learning model; and
based on determining the confidence value is below a threshold for confidence values transferring, by the auto discovery program, the input to the alternative machine learning model.

11. The computer system of claim 8, wherein the criteria relate to a group consisting of: a model function, a set of variables, an output, a classification, an accuracy of precision, a retrain frequency, feedbacks from users, security compliance rules, or a timeframe of activity of the machine learning model.

12. The computer system of claim 8, wherein determining the distance of the input further comprises:
determining a range for each of the plurality of features from a training set for the machine learning model; and
calculating an outlier of each feature from the input to the range of the feature from the plurality of feature.

13. The computer system of claim 8, wherein identifying the alternative machine learning model from the machine learning models further comprises:
determining the virtual group of the machine learning model; and
identifying the alternative machine learning model from the virtual group.

14. The computer system of claim 8, wherein transferring, by the auto discovery program, the input to the alternative machine learning model further comprises extrapolating missing features from the input is by fake feature generation mechanisms.

15. A computer program product for discovering and grouping of machine learning models, the computer program product comprising:
one or more computer-readable tangible storage medium and program instructions stored on at least one of the one or more tangible storage medium, the program instructions executable by a processor, the program instructions comprising:
program instructions to execute a discovery protocol, wherein the discovery protocol identifies each of the machine learning models and groups the machine learning models into one or more virtual groups based on criteria, and wherein the auto discovery program is injected to each of the machine learning models;
program instructions to identify an input to a machine learning model, wherein the input comprises a plurality of features that processed by the machine learning model;
based on determining a distance of the input is above an acceptable threshold:
program instructions to identify an alternative machine learning model from the machine learning models; and
program instructions to transfer the input to the alternative machine learning model.

16. The computer program product of claim 15, wherein the one or more virtual groups are omnidirectional based on a primary machine learning model from the machine learning models.

17. The computer program product of claim 15, further comprising:
program instructions to determine a confidence value generated by the machine learning model; and
based on determining the confidence value is below a threshold for confidence values program instructions to transfer the input to the alternative machine learning model.

18. The computer program product of claim 15, wherein the criteria relate to a group consisting of: a model function, a set of variables, an output, a classification, an accuracy of precision, a retrain frequency, feedbacks from users, security compliance rules, or a timeframe of activity of the machine learning model.

19. The computer program product of claim 15, wherein program instructions to determine the distance of the input further comprises:
program instructions to determine a range for each of the plurality of features from a training set for the machine learning model; and
program instructions to calculate an outlier of each feature from the input to the range of the feature from the plurality of feature.

20. The computer program product of claim 15, wherein program instructions to identify the alternative machine learning model from the machine learning models further comprises:
program instructions to determine the virtual group of the machine learning model; and
program instructions to identify the alternative machine learning model from the virtual group.
